(19) United States
(12) Patent Application Publication
(10) Pub. No.: US 2020/0203772 A1
(43) Pub. Date: Jun. 25, 2020

(54) MODIFIED IONIC LIQUIDS CONTAINING BORON

(71) Applicant: NOHMS Technologies, Inc., Rochester, NY (US)

(72) Inventors: Surya Moganty, Henrietta, NY (US); Luigi Abbate, Rochester, NY (US); Kevin Brown, Rochester, NY (US); Gabriel Torres, Rochester, NY (US); David Steele, Webster, NY (US)

(73) Assignee: NOHMS Technologies, Inc., Rochester, NY (US)

(21) Appl. No.: 16/722,920

(22) Filed: Dec. 20, 2019

Related U.S. Application Data
(60) Provisional application No. 62/783,380, filed on Dec. 21, 2018.

(51) Int. Cl. H01M 10/0567; H01M 10/0569; H01M 10/0568; C07F 5/04

(52) U.S. Cl. CPC H01M 10/0567; H01M 10/0569; H01M 2300/0028; C07F 5/04; H01M 10/0568

(57) ABSTRACT

The present disclosure is directed to a boron-modified ionic liquid compound, the synthesis thereof and an electrochemical cell electrolyte containing the boron-modified ionic liquid compound.

### CROSS REFERENCE

This application claims the benefit of the filing date of U.S. Provisional Patent Application Ser. No. 62/783,380, filed Dec. 21, 2018, which is hereby incorporated by reference in its entirety.

### FIELD

This disclosure is directed towards an ionic liquid whose cation includes a boron moiety and an electrolyte for electrochemical cells containing the ionic liquid.

### BACKGROUND

Recent progress in synthesis and electrochemical analysis of room temperature ionic liquids (ILs) has established the promise of this unique class of materials as electrolytes for next-generation lithium-ion batteries. ILs are organic salts having melting points below 100° C. and generally consist of a bulky cation and an inorganic anion. The large cation size allows for delocalization and screening of charges, resulting in a reduction in the lattice energy and thereby the melting point or glass transition temperature. ILs have unique physicochemical properties, such as negligible vapor pressure, non-flammability, good room-temperature ionic conductivity, a wide electrochemical window, and favorable chemical and thermal stability. These properties are desirable for providing IL-based electrolytes for lithium batteries.

However, there are still safety challenges such as flammability of lithium-ion batteries under abuse conditions or even normal conditions. U.S. Pat. No. 8,304,118 to Yoon et al. teaches the use of an electrolyte composition containing a boron-based non-aqueous solvent, but mentions no use of an ionic liquid, or of an ionic liquid covalently bonded to a moiety containing a boron. Therefore, there is a need to incorporate a novel ionic liquid with flame retardant capabilities into lithium ion batteries. Also, there is a need to extend the operating voltage to extract more capacity from the Li ion cathodes. However, the current generation electrolytes are not stable above 4.2V.

### SUMMARY

The present disclosure is directed towards an ionic liquid, including anions and cations, wherein the cations have at least one boron moiety.

In accordance with one aspect of the present disclosure, there is provided an electrolyte for use in an electrical storage device, the electrolyte includes an aprotic organic solvent, a metal salt, an additive and an ionic liquid compound that contains at least one boron moiety, wherein the cation of the metal salt is aluminum or magnesium or an alkali metal salt, such as lithium or sodium.

In accordance with another aspect of the present disclosure, there is provided an electrolyte in an electrical energy storage device, the electrolyte includes an aprotic organic solvent, a metal salt, an additive and an ionic liquid compound that contains at least one boron moiety, wherein the organic solvent is open-chain or cyclic carbonates, carboxylic acid esters, nitrites, ethers, sulfones, sulfoxides, ketones, lactones, dioxolanes, glymes, crown ethers, siloxanes, phosphoric acid esters, phosphates, phosphites, mono- or polyphosphazenes or mixtures thereof, wherein the cation of the metal salt is aluminum or magnesium or an alkali metal salt, such as lithium or sodium.

In accordance with another aspect of the present disclosure, there is provided an electrolyte in an electrical energy storage device, the electrolyte includes an aprotic organic solvent, a metal salt, an additive and the ionic liquid compound that contains at least one phosphorus moiety, wherein the cation of the metal salt is aluminum or magnesium or an alkali metal salt, such as lithium or sodium.

In accordance with another aspect of the present disclosure, there is provided an electrolyte in an electrical energy storage device, the electrolyte including an aprotic organic solvent, a metal salt, an additive and an ionic liquid compound that contains at least one phosphorus moiety, wherein the additive contains sulfur-containing compounds, phosphorus-containing compounds, boron-containing compounds, silicon-containing compounds, compounds containing at least one unsaturated carbon-carbon bond, carboxylic acid anhydrides or mixtures thereof, wherein the cation of the metal salt is aluminum or magnesium or an alkali metal salt, such as lithium or sodium.

These and other aspects of the present disclosure will become apparent upon a review of the following detailed description and the claims appended thereto.

### DETAILED DESCRIPTION

The present disclosure is directed towards an ionic liquid compound including at least one cation and at least one anion, wherein the at least one cation is covalently bonded to at least one boron moiety.

In an embodiment, an electrical energy storage device electrolyte includes a) an aprotic organic solvent system; b) a metal salt; c) an additive; and d) an ionic liquid compound including at least one cation and an at least one anion, wherein at least one cation is covalently bonded to at least one boron moiety, wherein the cation of the metal salt is aluminum or magnesium or an alkali metal salt, such as lithium or sodium.

In an embodiment, an ionic liquid compound includes an anion; and a cation attached to a boron moiety according to the formula:

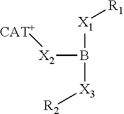

wherein: CAT⁺ is a pyrrolidinium, piperdinium, azepanium, onium, sulfonium, phosphonium, imidazolium, pyridine or a 5- or 6-membered heterocyclic ring having 1 to 3 heteroatoms as ring members including nitrogen, oxygen, silicon or sulfur; R₁ and R₂ are independently, CAT⁺, methyl, or a C₂-C₈ alkyl, alkenyl, alkoxy, aryl, alkynyl, alkylsiloxy, phenyl, benzyl, silyl, thioether, sulfoxide, azo, amino or silane group, wherein any of the carbon or hydrogen atoms therein are optionally further substituted with a halide, alkyl, alkenyl, alkoxy, aryl, alkynyl, alkylsiloxy, phenyl, benzyl, silyl, thioether, sulfoxide, azo, amino or silane; and X₁, X₂, and X₃ are independently (a) a linker, including methylene, a C₂-C₈ alkyl, alkenyl, alkynyl, alkoxy, ester, carbonyl, phenyl, thioether, sulfoxide, azo or aryl group, wherein any of the carbon or hydrogen atoms therein are optionally further substituted with a halide; (b) O, S, N, or C; or (c) O, S, N, or C attached to the linker.

Suitable anions in accordance with the present disclosure, include but are not limited to halides (e.g., Cl, Br), nitrates (e.g., NO₃), phosphates (e.g., PF₆, TFOP), imides (e.g., TFSI, BETI), borates (e.g., BOB, BF₄), aluminates, arsenides, cyanides, thiocyanates, nitrites, benzoates, carbonates, chlorates, chlorites, chromates, sulfates, sulfites, silicates, thiosulfates, chalcogenides, pnictogenides, oxalates, acetates, formates, or hydroxides.

The disclosure further includes a method for synthesizing the boron cations, and the use of such functionalized cations in an ionic liquid for electrochemical cells. These compounds afford the electrolyte greater thermal stability.

In some embodiments, the electrolyte includes a lithium salt in addition to the ionic liquid. A variety of lithium salts may be used, including, for example, Li[CF₃CO₂];Li[C₂F₅CO₂]; Li[ClO₄]; Li[BF₄]; Li[AsF₆]; Li[PF₆]; Li[PF₂(C₂O₄)₂]; Li[PF₄C₂O₄]; Li[CF₃SO₃]; Li[N(CP₃SO₂)₂]; Li[C(CF₃SO₂)₃]; Li[N(SO₂C₂F₅)₂]; lithium alkyl fluorophosphates; Li[B(C₂O₄)₂]; Li[BF₂C₂O₄]; Li₂[B₁₂Z₁₂₋ⱼHⱼ]; Li₂[B₁₀X₁₀₋ⱼ′Hⱼ′]; or a mixture of any two or more thereof, wherein Z is independent at each occurrence a halogen, j is an integer from 0 to 12 and j′ is an integer from 1 to 10.

In some applications of the present electrolyte, such as a formulation for a lithium ion battery, aprotic solvents are combined with the present ionic liquids to decrease the viscosity and increase the conductivity of the electrolyte. The most appropriate aprotic solvents lack exchangeable protons, including cyclic carbonic acid esters, linear carbonic acid esters, phosphoric acid esters, oligoether substituted siloxanes/silanes, cyclic ethers, chain ethers, lactone compounds, chain esters, nitrile compounds, amide compounds, sulfone compounds, siloxanes, phosphoric acid esters, phosphates, phosphites, mono- or polyphosphazenes and the like. These solvents may be used singly, or at least two of them in admixture. Examples of aprotic solvents or carriers for forming the electrolyte systems include but are not limited to dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, ethyl propionate, butyl propionate, dimethoxyethane, triglyme, dimethylvinylene carbonate, tetraethyleneglycol, dimethyl ether, polyethylene glycols, triphenyl phosphate, tributyl phosphate, hexafluorocyclotriphosphazene, 2-Ethoxy-2,4,4,6,6-pentafluoro-1,3,5,2-5,4-5,6-5 triazatriphosphinine, triphenyl phosphite, sulfolane, dimethyl sulfoxide, ethyl methyl sulfone, ethylvinyl sulfone, allyl methyl sulfone, divinyl sulfone, fluorophynelmethyl sulfone and gamma-butyrolactone.

In some embodiments, the electrolytes further include an additive to protect the electrodes from degradation. Thus, electrolytes of the present technology may include an additive that is reduced or polymerized on the surface of a negative electrode to form a passivation film on the surface of the negative electrode. Likewise, electrolytes can include an additive that can be oxidized or polymerized on the surface of the positive electrode to form a passivation film on the surface of the positive electrode. In some embodiments, electrolytes of the present technology further include mixtures of the two types of additives.

In some embodiments, an additive is a substituted or unsubstituted linear, branched or cyclic hydrocarbon including at least one oxygen atom and at least one aryl, alkenyl or alkynyl group. The passivating film formed from such additives may also be formed from a substituted aryl compound or a substituted or unsubstituted heteroaryl compound where the additive includes at least one oxygen atom. Alternatively, a combination of two additives may be used. In some such embodiments, one ion and the other additive can be selective for passivating the anode surface to prevent or lessen the reduction of metal ions at the anode.

Representative additives include glyoxal bis(diallyl acetal), tetra(ethylene glycol) divinyl ether, 1,3,5-triallyl-1,3,5-triazine-2,4,6(1H,3H,5H)-trione, 1,3,5,7-tetravinyl-1,3,5,7-tetramethylcyclotetrasiloxane, 2,4,6-triallyloxy-1,3,5-triazine, 1,3,5-triacryloylhexahydro-1,3,5-triazine, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2-amino-3-vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2-vinyloxetane, 2-vinyloxy-cyclopropanone, 3-(N-vinylamino)cyclohexanone, 3,5-divinyl furoate, 3-vinylazetidin-2-one, 3 vinylaziridin-2-one, 3-vinylcyclobutanone, 3-vinylcyclopentanone, 3-vinyloxaziridine, 3-vinyloxetane, 3-vinylpyrrolidin-2-one, 2-vinyl-1,3-dioxolane, acrolein diethyl acetal, acrolein dimethyl acetal, 4,4-divinyl-3-dioxolan-2-one, 4-vinyltetrahydropyran, 5-vinylpiperidin-3-one, allylglycidyl ether, butadiene monoxide, butyl-vinyl-ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone or a mixture of any two or more thereof. In some embodiments, the additive may be a cyclotriphosphazene that is substituted with F, alkyloxy, alkenyloxy, aryloxy, methoxy, allyloxy groups or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)cyclotriphosphazene or (diaryloxy)(trifluoro)(methoxy)cyclotriphosphazene compounds or a mixture of two or more such compounds. In some embodiments, the additive is vinyl ethylene carbonate, vinyl carbonate, or 1,2-diphenyl ether, or a mixture of any two or more such compounds.

Other representative additives include compounds with phenyl, naphthyl, anthracenyl, pyrrolyl, oxazolyl, furanyl, indolyl, carbazolyl, imidazolyl, thiophenyl, fluorinated carbonates, sultone, sulfide, anhydride, silane, siloxy, phosphate or phosphite groups. For example, additives may be phenyl trifluoromethyl sulfide, fluoroethylene carbonate, 1,3,2-dioxathiolane 2,2-dioxide, 1-propene 1,3-sultone, 1,3-propanesultone, 1,3-dioxolan-2-one, 4-[(2,2,2-trifluoroethoxy)methyl], 1,3-dioxolan-2-one, 4-[[2,2,2-trifluoro-1-(trifluoromethyl)ethoxy]methyl]-, methyl 2,2,2-trifluoroethyl carbonate, nonafluorohexyltriethoxysilane, octamethyltrisiloxane, methyltris(trimethylsiloxy)silane, tetrakis(trimethylsiloxy)silane, (tridecafluoro-1,1,2,2-tetrahydrooctyl)triethoxysilane, tris(1H.1H-heptafluorobutyl)phosphate, 3,3,3-trifluoropropyltris(3,3,3 -trifluoropropyldimethylsiloxy)silane, (3,3,3-trifluoropropyl)trimethoxysilane, trimethylsilyl trifluoromethanesulfonate, tris(trimethylsilyl) borate, tripropyl phosphate, bis(trimethylsilylmethyl)benzylamine, phenyltris(trimethylsiloxy)silane, 1,3-bis(trifluoropropyl)tetramethyldisiloxane, triphenyl phosphate, tris(trimethylsilyl)phosphate, tris(1H.1H,5H-octafluoropentyl)phosphate, triphenyl phosphite, trilauryl trithiophosphite, tris(2,4-di-tert-butylphenyl) phosphite, tri-p-tolyl phosphite, tris(2,2,3,3,3-pentafluoropropyl)phosphate, succinic anhydride, 1,5,2,4-dioxadithiane 2,2,4,4-tetraoxide, tripropyl trithiophosphate, aryloxpyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydrofuran-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4 divinyl-1-methyl pyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cycolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxyquinoline, diaryloxycyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o terphenyl, N-methyl pyrrole, naphthalene or a mixture of any two or more such compounds.

In some other embodiments, the electrolyte of the present technology includes an aprotic gel polymer carrier/solvent. Suitable gel polymer carrier/solvents include polyethers, polyethylene oxides, polyimides, polyphosphazines, polyacrylonitriles, polysiloxanes, polyether grafted polysiloxanes, derivatives of the foregoing, copolymers of the foregoing, cross-linked and network structures of the foregoing, blends of the foregoing and the like, to which is added a suitable ionic electrolyte salt. Other gel-polymer carrier/solvents include those prepared from polymer matrices derived from polypropylene oxides, polysiloxanes, sulfonated polyimides, perfluorinated membranes (Nafion resins), divinyl polyethylene glycols, polyethylene glycol-bis-(methyl acrylates), polyethylene glycol-bis(methyl methacrylates), derivatives of the foregoing, copolymers of the foregoing and cross-linked and network structures of the foregoing.

The functional ionic liquids and the electrolytic solution containing the salt are high in electrical conductivity and solubility in organic solvents, and thus are suitable for use as an electrolytic solution for electrochemical devices. Examples of electrochemical devices are electric double-layer capacitor, secondary batteries, solar cells of the pigment sensitizer type, electrochromic devices and condensers, and this list is not limitative. Especially suitable as electrochemical devices are electric double-layer capacitor and secondary batteries, such as a lithium ion battery.

In yet another aspect, an electrochemical device is provided that includes a cathode, an anode and an electrolyte including an ionic liquid as described herein. In one embodiment, the electrochemical device is a lithium secondary battery. In some embodiments, the secondary battery is a lithium battery, a lithium-ion battery, a lithium-sulfur battery, a lithium-air battery, a sodium ion battery or a magnesium battery. In some embodiments, the electrochemical device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery. In some embodiments, the electrochemical cell is a solar cell.

Suitable cathodes include those such as, but not limited to, a lithium metal oxide, spinel, olivine, carbon-coated olivine, LiFePO₄, LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiMn₂O₄, LiFeO₂, Li₁₊ₓ′Ni_{α}Mn_{β}Co_{γ}Met′_{δ}O_{2-z}′F_{z}′, Aₙ′B₂(XO₄)₃ (NASICON), vanadium oxide, lithium peroxide, sulfur, polysulfide, a lithium carbon monofluoride (also known as LiCFx) or mixtures of any two or more thereof, where Met is Al, Mg, Ti, B, Ga, Si, Mn or Co; Met' is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤h′≤3. According to some embodiments, the spinel is a spinel manganese oxide with the formula of Li₁₊ₓMn_{2-z}Met′″_{y}O₄₋ₘX′ₙ, wherein Met′″ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of Li₁₊ₓFe_{1-z}Met″_{y}PO₄₋ₘX′ₙ, wherein Met” is Al, Mg, Ti, B, Ga, Si, Ni, Mn or Co; X′ is S or F; and wherein 0≤x≤0.3, 0 0≤y≤0.5, 0≤z≤0.5, 0≤m≤0.5 and 0≤n≤0.5.

Suitable anodes include those such as lithium metal, graphitic materials, amorphous carbon, Li₄Ti₅O₁₂, tin alloys, silicon alloys, intermetallic compounds or mixtures of any two or more such materials. Suitable graphitic materials include natural graphite, artificial graphite, graphitized meso-carbon microbeads (MCMB) and graphite fibers, as well as any amorphous carbon materials. In some embodiments, the anode and cathode are separated from each other by a porous separator.

The separator for the lithium battery often is a microporous polymer film. Examples of polymers for forming films include: nylon, cellulose, nitrocellulose, polysulfone, polyacrylonitrile, polyvinylidene fluoride, polypropylene, polyethylene, polybutene, or co-polymers or blends of any two or more such polymers. In some instances, the separator is an electron beam-treated micro-porous polyolefin separator. The electron treatment can improve the deformation temperature of the separator and can accordingly enhance the high temperature performance of the separator. Additionally, or alternatively, the separator can be a shut-down separator. The shut-down separator can have a trigger temperature above about 130° C. to permit the electrochemical cells to operate at temperatures up to about 130° C.

Although various embodiments have been depicted and described in detail herein, it will be apparent to those skilled in the relevant art that various modifications, additions, substitutions and the like can be made without departing from the spirit of the disclosure and these are therefore considered to be within the scope of the disclosure as defined in the claims which follow.

The disclosure will be further illustrated with reference to the following specific example. It is understood that this example is given by way of illustration and is not meant to limit the disclosure or the claims to follow.

### EXAMPLE

### Synthesis of (methyl hydroxyethylpyrollidine-Iodide)3-Borate

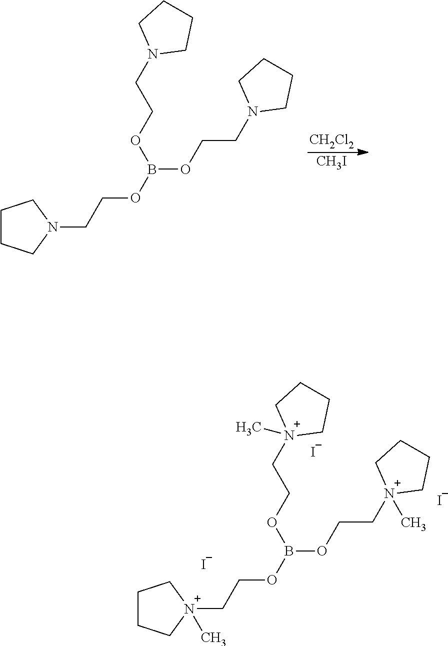

| | | | | Mass | | Volume | | Yield |
|---|---|---|---|---|---|---|---|---|
| Reagent | MW | Equiv | Mol | (g) | Density | (mL) | Conc | (calc) |
| tris-ethylpyrollidine Borate | 353.31 | 1.00 | 0.081 | 28.6 | | | | |
| Methyl Iodide | 141.94 | 3.00 | 0.243 | 34.5 | 0.985 | 35.0 | 0.8M | |
| Dichloromethane | | | | 173.0 | 0.865 | 200.0 | 86% | |
| | | | 0.000 | 0.0 | | | | |
| (Pyr120-I)3_Borate | 779.12 | 1.00 | 0.081 | | | | | 63.1 |
| | | | 0.000 | | | | | 0.0 |

The tris-ethylpyrrolidine Borate prepared in DS2-54 was dissolved in 200 mls of Dichloromethane and charged to a 1000 ml 3-neck round bottom flask equipped with a nitrogen inlet, addition funnel and thermal couple. The reaction was magnetically stirred and treated dropwise with 3 equivalents of methyl iodide (34.5 grams). During addition the temperature rose from 22 to 40.7° C., causing a mild reflux to occur, which lasted during the addition. The clear solution also became cloudy during the addition. The mixture was magnetically stirred for 3 hours, or until the temperature drops to room temperature.

After 3 hours the stirring had stopped. The product had oiled out of the Dichloromethane creating two layers. The reaction was transferred to a separatory funnel and the two layers separated.

The bottom layer was placed on the roto evaporator and concentrated to remove any solvent still present. Obtained 83 grams of a light orangish oil (still solvent present as the amount is more than theoretical).

NMR is consistent with the expected structure.

H⁺ NMR: (CDCl3) δ ppm 3.83(b, 2H) 3.50 (m, 4H) 3.43 (t, 2H) 3.05 (s, 2H) 2.08 (m, 4H), plus some solvent and minor impurities.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed

1. An ionic liquid compound, comprising:
an anion; and
a cation attached to a boron moiety according to the formula: 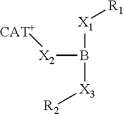
wherein:
CAT⁺ is a pyrrolidinium, piperdinium, azepanium, onium, sulfonium, phosphonium, imidazolium, pyridine or a 5- or 6-membered heterocyclic ring having 1 to 3 heteroatoms as ring members comprising nitrogen, oxygen, silicon or sulfur;
R₁ and R₂ are independently, CAT⁺, a methyl, or C₂-C₈ alkyl, alkenyl, alkoxy, aryl, alkynyl, alkylsiloxy, phenyl, benzyl, silyl, thioether, sulfoxide, azo, amino or silane group, wherein any of the carbon or hydrogen atoms therein are optionally further substituted with a halide, alkyl, alkenyl, alkoxy, aryl, alkynyl, alkylsiloxy, phenyl, benzyl, silyl, thioether, sulfoxide, azo, amino or silane;
X₁, X₂, and X₃ are independently (a) a linker comprising a methylene, or C₂-C₈ alkylene, alkenylene, alkynylene, alkoxy, ester, carbonylene, phenylene, thioether, sulfoxide, azo or arylene group, wherein any of the carbon or hydrogen atoms therein are optionally further substituted with a halide; (b) O, S, or C; or (c) O, S, N, or C attached to the linker.

2. The compound of claim 1, wherein the anion comprises a halide, aluminates, arsenides, cyanides, thiocyanates, nitrites, benzoates, chlorates, chlorites, chromates, sulfates, sulfites, silicates, thiosulfates, oxalates, acetates, formates, hydroxides, nitrate, phosphate, imide, or borate.

3. An electrical energy storage device electrolyte comprising:
a) an aprotic organic solvent system;
b) a metal salt;
c) an additive; and
d) an ionic liquid compound according to claim 1.

4. The electrolyte of claim 3, wherein the anion comprises a halide, aluminates, arsenides, cyanides, thiocyanates, nitrites, benzoates, chlorates, chlorites, chromates, sulfates, sulfites, silicates, thiosulfates, oxalates, acetates, formates, hydroxides, nitrate, phosphate, imide, or borate.

5. The electrolyte of claim 3, wherein the aprotic organic solvent comprises open-chain or cyclic carbonates, carboxylic acid esters, nitrites, ethers, sulfones, ketones, lactones, dioxolanes, glymes, crown ethers, siloxanes, phosphoric acid esters, phosphates, phosphites, mono- or polyphosphazenes or mixtures thereof.

6. The electrolyte of claim 3, wherein the cation of the metal salt comprises aluminum or magnesium.

7. The electrolyte of claim 3, wherein the cation of the metal salt comprises an alkali metal salt.

8. The electrolyte of claim 7, wherein the cation of the alkali metal salt comprises lithium or sodium.

9. The electrolyte of claim 3, wherein the additive comprises sulfur-containing compounds, phosphorus-containing compounds, boron-containing compounds, silicon-containing compounds, fluorine-containing compounds, nitrogen-containing compounds, compounds containing at least one unsaturated carbon-carbon bond, carboxylic acid anhydrides or the mixtures thereof.
